(19) United States
(12) Patent Application Publication
(10) Pub. No.: US 2026/0277158 A1
(43) Pub. Date: Sep. 17, 2026

(54) GEAR SET, MOVEMENT, AND TIMEPIECE

(71) Applicant: SEIKO EPSON CORPORATION, Tokyo (JP)

(72) Inventors: Takeo FUNAKAWA, CHINO-SHI (JP); Eiichi NAGASAKA, MINOWA-MACHI (JP)

(21) Appl. No.: 19/563,933

(22) Filed: Mar. 11, 2026

(30) Foreign Application Priority Data
Mar. 13, 2025 (JP) 2025-040330

(51) Int. Cl. G04B 13/02

(52) U.S. Cl. CPC G04B 13/02

(57) ABSTRACT

A gear set includes a first gear and a second gear. Each tooth of the first gear includes a rigid tooth and an elastic tooth provided away from the rigid tooth via a slit. A tooth thickness of each tooth of the first gear, which is a sum of a thickness of the rigid tooth, a width dimension of the slit, and a thickness of the elastic tooth of the first gear on a pitch circle of the first gear in a free state, is equal to or larger than a width of a tooth groove of the second gear on a pitch circle of the second gear, and a width of a tooth groove of the first gear on the pitch circle of the first gear is equal to or less than a tooth thickness of each tooth of the second gear on the pitch circle thereof.

### CROSS-REFERENCE TO RELATED APPLICATIONS

The present application is based on, and claims priority from JP Application Serial Number 2025-040330, filed Mar. 13, 2025, the disclosure of that is hereby incorporated by reference herein in its entirety.

### BACKGROUND OF THE INVENTION

### 1. Technical Field

The present disclosure relates to a gear set, a movement, and a timepiece.

### 2. Related Art

In order to reduce a backlash, a gear provided with elastically deformable teeth is known. For example, JP-T-2007-518981 discloses a gear having a backlash-compensating tooth with two elastic bending portions.

The gear with a backlash-compensating tooth of JP-T-2007-518981 transmits motion while the elastic bent portion contacts the tooth of another gear and is elastically deformed. Therefore, it is difficult to stably transmit motion to another gear.

### SUMMARY OF THE INVENTION

A gear set according to an aspect of the present disclosure includes a first gear and a second gear. Each tooth of the first gear includes a rigid tooth including a first acting tooth face that transmits motion to the second gear or to which motion from the second gear is transmitted and an elastic tooth provided away from the rigid tooth via a slit, configured to bend in a direction toward the rigid tooth when the elastic tooth meshes with the second gear, and including a first non-acting tooth face that contacts the second gear. A tooth thickness of each tooth of the first gear, the tooth thickness being a sum of a thickness of the rigid tooth, a width dimension of the slit, and a thickness of the elastic tooth of the first gear on a pitch circle of the first gear in a free state in which the first gear does not mesh with the second gear, is equal to or larger than a width of a tooth groove of the second gear on a pitch circle of the second gear. A width of a tooth groove of the first gear on the pitch circle of the first gear is equal to or less than a tooth thickness of each tooth of the second gear on the pitch circle of the second gear.

A movement according to an aspect of the present disclosure includes the gear set.

A timepiece according to an aspect of the present disclosure includes the movement.

### BRIEF DESCRIPTION OF DRAWINGS

FIG. 1 is a plan view of a mechanical timepiece.

FIG. 2 is a plan view of a movement of the mechanical timepiece when viewed from the front.

FIG. 3 is a plan view showing a configuration of a third wheel and pinion as a first gear.

FIG. 4 is an enlarged plan view showing a tooth of the third wheel and pinion as the first gear.

FIG. 5 is an enlarged view showing a meshing state between the third wheel and pinion as the first gear and a seconds wheel as a second gear.

FIG. 6 is an enlarged view showing a meshing state between the third wheel and pinion as the first gear and the seconds wheel as the second gear.

FIG. 7 is an enlarged view showing a meshing state of the third wheel and pinion as the first gear and the seconds wheel as the second gear.

FIG. 8 is an enlarged view showing a meshing state of the third wheel and pinion as the first gear and the seconds wheel as the second gear.

### DETAILED DESCRIPTION OF THE INVENTION

Hereinafter, a gear set, a movement, and a timepiece of the present embodiment will be described with reference to the drawings.

In each of the following drawings, in order to make each layer or each member have a recognizable size, each layer and each member may be illustrated on a scale different from an actual scale.

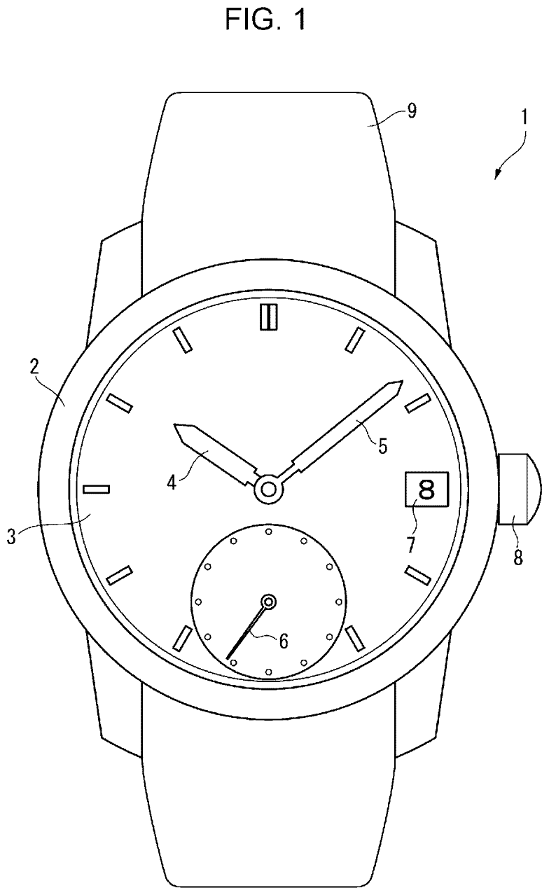

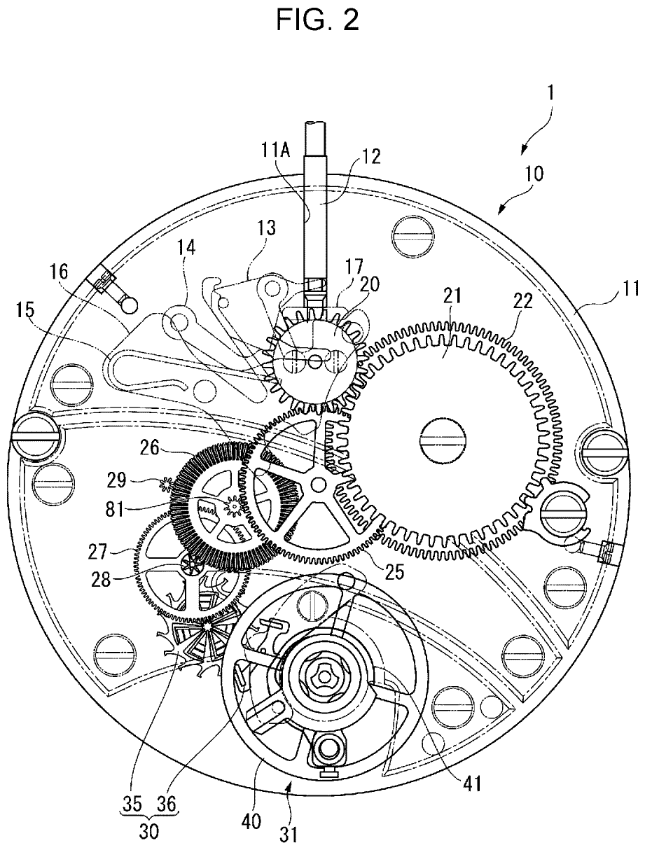

FIG. 1 is a plan view showing a mechanical timepiece 1, and FIG. 2 is a plan view showing a movement 10 of the mechanical timepiece 1. In the present embodiment, in the mechanical timepiece 1, a side on which a cover glass is disposed is referred to as a back side, and a side on which a case back is disposed is referred to as a front side. For this reason, FIG. 1 is a plan view of the mechanical timepiece 1 when viewed from the cover glass side, and the observer side of the sheet of FIG. 1 is the back side and the far side of the sheet is the front side. FIG. 2 is a plan view of the movement 10 when viewed from the case back side, and the observer side of the sheet of FIG. 2 is the front side and the far side of the sheet is the back side.

As shown in FIG. 1, the mechanical timepiece 1 includes a casing 2 and a strap 9. The casing 2 houses a dial 3, an hour hand 4, a minute hand 5, a small seconds hand 6, a date indicator 7, and the movement 10 shown in FIG. 2. A crown 8 is provided on a side face of the casing 2. The mechanical timepiece 1 is an example of a timepiece.

As shown in FIG. 2, the movement 10 has a main plate 11. The main plate 11 is a plate member for supporting and positioning each component. The dial 3 is disposed on the back side of the main plate 11. A train wheel including a plurality of gears is disposed on the front side and the back side of the main plate 11. The train wheel disposed on the front side of the main plate 11, that is, the case back side, is referred to as a front train wheel, and the train wheel disposed on the back side of the main plate 11, that is, the dial 3 side, is referred to as a back train wheel.

The main plate 11 has a setting stem guide hole 11A for guiding a shaft-like setting stem 12 in parallel with the main plate 11 and in a direction from the outer edge toward the center. The setting stem 12 is incorporated so as to be movable in the axial direction and rotatable around the shaft with respect to the setting stem guide hole 11A. The crown 8 is attached to the distal end of the setting stem 12. A setting lever 13, a yoke 14, a yoke spring 15 and a setting lever jumper 16 are disposed in the vicinity of the setting stem 12. The setting lever 13, the yoke 14, the yoke spring 15, and the setting lever jumper 16 constitute a switching mechanism for switching between the transmission destinations of the rotational force of the setting stem 12.

The setting stem 12 is inserted into a winding pinion 17 that is coaxially rotatable with the setting stem 12. Further, a clutch wheel (not shown) that rotates together with the setting stem 12 is disposed at the setting stem 12. The clutch wheel rotates coaxially with the setting stem 12, and is movable along the axial direction of the setting stem 12 by the switching mechanism. When the position of the setting stem 12 is changed in the axial direction, the switching mechanism switches between a state in which the clutch wheel and the winding pinion 17 mesh with each other and a state in which they do not mesh with each other. A crown wheel 20 that meshes with the winding pinion 17, a ratchet wheel 21 that meshes with the crown wheel 20, and a barrel complete 22 that houses a mainspring are rotatably installed at the main plate 11.

When the setting stem 12 moves along the axial direction and is disposed at a first setting stem position closest to the center of the movement 10, the clutch wheel and the winding pinion 17 mesh with each other. In this state, when the operator operates the crown 8 to rotate the setting stem 12, the winding pinion 17 rotates together with the clutch wheel. When the winding pinion 17 rotates, the crown wheel 20 rotates. When the crown wheel 20 rotates, the ratchet wheel 21 rotates. Further, when the ratchet wheel 21 rotates, the mainspring housed in the barrel complete 22 is wound up. The mainspring is a power source for driving the movement 10. When the setting stem 12 is disposed at a position outside the first setting stem position, the meshing with the clutch wheel and the winding pinion 17 is released, and the clutch wheel meshes with a setting wheel (not shown) for performing time setting or the like.

A center wheel and pinion 25, a third wheel and pinion 26 and a seconds wheel and pinion 27 are rotatably disposed at the main plate 11. Each of the center wheel and pinion 25, the third wheel and pinion 26, and the seconds wheel and pinion 27 includes a gear and a pinion which are integrally rotated. The above-described front train wheel is constituted by the barrel complete 22, the center wheel and pinion 25, the third wheel and pinion 26, and the seconds wheel and pinion 27. The front train wheel has a function of transmitting the rotational force of the barrel complete 22. An escapement mechanism 30 and a regulator mechanism 31 are disposed at the main plate 11 on the front side of the movement 10. The escapement mechanism 30 and the regulator mechanism 31 adjust the rotation speed of the front train wheel.

The barrel complete 22 meshes with a pinion (not shown) of the center wheel and pinion 25. A cannon pinion (not shown) is attached to the center wheel and pinion 25, and the minute hand 5 is attached to the cannon pinion. Further, the cannon pinion meshes with a minute wheel of a back train wheel (not shown), and the minute wheel meshes with an hour wheel of the back train wheel (not shown). The hour hand 4 is attached to the hour wheel.

A pinion 81 of the third wheel and pinion 26 meshes with a gear of the center wheel and pinion 25. The third wheel and pinion 26 meshes with a pinion 28 of the seconds wheel and pinion 27 and a seconds wheel 29 for the small seconds hand 6.

The escapement mechanism 30 is a mechanism that controls the rotation of the front train wheel. The escapement mechanism 30 includes an escape wheel and pinion 35 and a pallet fork 36. The escape wheel and pinion 35 has a pinion which meshes with a gear of the seconds wheel and pinion 27, and rotates by receiving torque of the seconds wheel and pinion 27. The pallet fork 36 regularly rotates the escape wheel and pinion 35 in accordance with the operation of the regulator mechanism 31. The regulator mechanism 31 includes a balance with hairspring 40, a hairspring 41, and the like, and adjusts the rotation speed of the escape wheel and pinion 35 by swinging the balance with hairspring 40 at a constant cycle, thereby adjusting the rotation speed of the front train wheel meshing with the escape wheel and pinion 35.

Next, among the various components described above, the third wheel and pinion 26 will be described in detail.

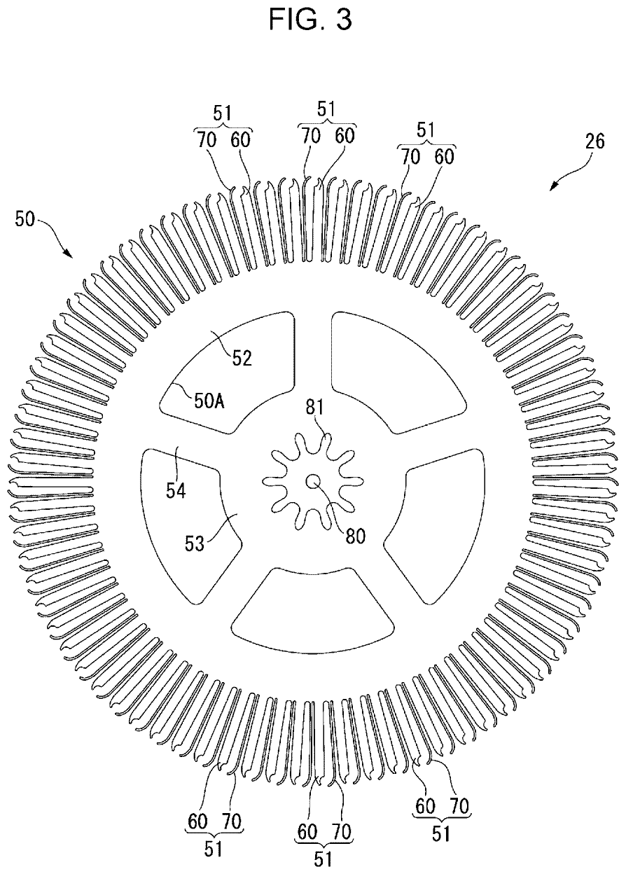

FIG. 3 is a plan view showing a configuration of the third wheel and pinion 26.

As shown in FIG. 3, the third wheel and pinion 26 includes a gear 50 and a shaft portion 80 serving as a rotation shaft of the gear 50. The gear 50 includes an annular rim portion 52 having a plurality of teeth 51 on its outer circumferential face, a holding portion 53 through which the shaft portion 80 is inserted, and a plurality of coupling portions 54 extending radially from the holding portion 53 and coupling the rim portion 52 and the holding portion 53. The gear 50 has an opening portion 50A surrounded by the rim portion 52, the holding portion 53, and two adjacent coupling portions 54. The gear 50 meshes with the pinion 28 included in the seconds wheel and pinion 27 and the seconds wheel 29.

In the present embodiment, the gear 50 of the third wheel and pinion 26 is a first gear, and each of the pinion 28 and the seconds wheel 29 which mesh with the gear 50 is a second gear. In addition, a gear set is configured by the gear 50 that is the first gear, and the pinion 28 or the seconds wheel 29 which is the second gear.

The shaft portion 80 has the pinion 81 integrally formed to mesh with a gear of the center wheel and pinion 25. The shaft portion 80 is inserted into a hole portion (not shown) formed at the center of the gear 50 and is fixed to the gear 50. Therefore, the gear 50 rotates integrally with the pinion 81.

The gear 50 has a plate shape and has a substantially uniform thickness over the entire face. The gear 50 is made of a brittle material having crystal orientation, such as single crystal silicon. The material of the gear 50 of the present embodiment is single crystal silicon. Specifically, the gear 50 is formed by etching a silicon wafer made of single crystal silicon. A method of manufacturing the gear 50 will be described later.

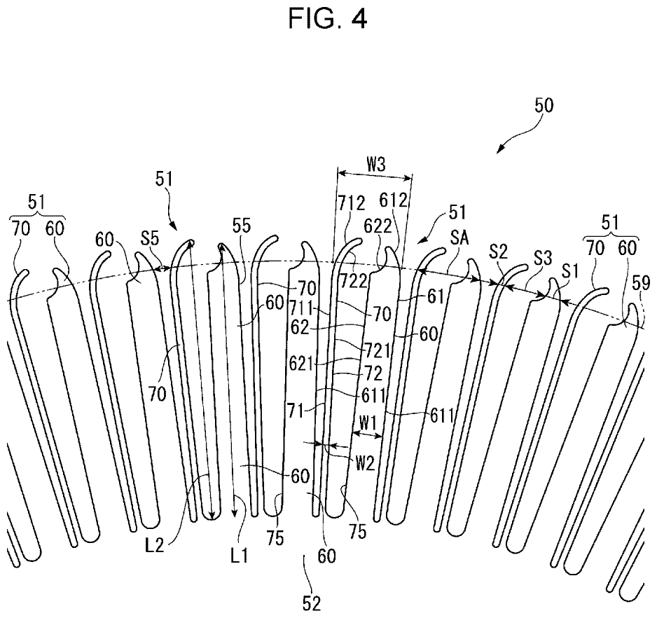

As shown in FIGS. 3 and 4, the gear 50 includes a plurality of teeth 51 each composed of a rigid tooth 60 and an elastic tooth 70.

The rigid teeth 60 are formed radially from the rim portion 52, and are formed at regular intervals along the outer circumference of the rim portion 52. The elastic teeth 70 are formed radially from the rim portion 52, and are formed at regular intervals along the outer circumference of the rim portion 52. Further, the rigid teeth 60 and the elastic teeth 70 are alternately formed along the outer circumference of the rim portion 52.

Each of the plurality of teeth 51 is composed of the rigid tooth 60 and the elastic tooth 70 which are curved in a direction in which their distal ends approach each other.

The rigid tooth 60 is a drive tooth for transmitting motion to the pinion 28 of the seconds wheel and pinion 27 and the seconds wheel 29, and as shown in FIG. 4, includes a first acting tooth face 61 and an inner face 62.

The first acting tooth face 61 is a face that contacts the pinion 28 and the seconds wheel 29 to transmit motion, and includes an acting tooth root face 611 and an acting curved face 612. The acting tooth root face 611 is a face extending substantially linearly along the radial direction from the rim portion 52. The acting curved face 612 is a face which extends from the acting tooth root face 611 toward the tooth tip and is curved toward the elastic tooth 70, and is a face which comes into contact with the teeth of the pinion 28 and the seconds wheel 29 and transmits the motion.

The inner face 62 is a face that faces the elastic tooth 70 and defines a slit 75 between the inner face 62 and the elastic tooth 70. The inner face 62 includes a proximal end face 621 and a distal end face 622. The proximal end face 621 extends substantially linearly from the rim portion 52, and is provided substantially parallel to the acting tooth root face 611. A width dimension W1 between the acting tooth root face 611 and the proximal end face 621 is substantially constant, for example, about 100 μm. The width dimension W1 of the rigid tooth 60 is set so that when the rigid tooth 60 meshes with other gears such as the pinion 28 and the seconds wheel 29, the rigid tooth 60 can transmit motion without elastic deformation.

The distal end face 622 is a curved face that extends from the proximal end face 621 toward the tooth tip and is curved toward the acting curved face 612. For this reason, the width dimension between the acting curved face 612 and the distal end face 622 is formed so as to become smaller toward the tooth tip of the rigid tooth 60.

The elastic tooth 70 is a tooth that is not used for transmission of motion and is elastically deformed and bent to contact teeth of the pinion 28 or the seconds wheel 29, thereby compensating for a backlash, and includes a first non-acting tooth face 71 and an inner face 72. The first non-acting tooth face 71 is a face that contacts the pinion 28 or the seconds wheel 29 to compensate for a backlash, and includes a non-acting tooth root face 711 and a non-acting curved face 712. The non-acting tooth root face 711 is a face extending substantially linearly along the radial direction from the rim portion 52. The non-acting curved face 712 is a face that extends from the non-acting tooth root face 711 toward the tooth tip and is curved toward the rigid tooth 60, and is a face which contacts the teeth of the pinion 28 or the seconds wheel 29.

The inner face 72 is a face that faces the rigid tooth 60 and defines the slit 75 between the inner face 72 and the rigid tooth 60. The inner face 72 includes a proximal end face 721 and a distal end face 722. The proximal end face 721 extends substantially linearly from the rim portion 52 and is provided substantially parallel to the non-acting tooth root face 711. A width dimension W2 between the non-acting tooth root face 711 and the proximal end face 721 is substantially constant, for example, about 30 μm. The distal end face 722 is a curved face that extends from the proximal end face 721 toward the tooth tip and is curved as in the non-acting curved face 712. The width dimension between the non-acting curved face 712 and the distal end face 722 is substantially equal to the width dimension W2. The width dimension W2 of the elastic tooth 70 is smaller than the width dimension W1 of the rigid tooth 60, so that the elastic tooth 70 can be elastically deformed as a whole.

As described above, the tooth 51 includes the rigid tooth 60 and the elastic tooth 70, and has the slit 75 between the rigid tooth 60 and the elastic tooth 70. The slit 75 is defined by the inner face 62 of the rigid tooth 60, the rim portion 52, and the inner face 72 of the elastic tooth 70. A width dimension W3 of the tooth 51 is a value obtained by adding the width dimension W1 of the rigid tooth 60, the width dimension W2 of the elastic tooth 70, and the width dimension of the slit 75, and the width dimension W3 is, for example, about 220 μm in a free state in which the tooth 51 does not mesh with the pinion 28 or the seconds wheel 29.

A length dimension L1 from the tooth root of the rigid tooth 60, that is, the rim portion 52, to the tooth tip and a length dimension L2 from the tooth root of the elastic tooth 70 to the tooth tip are set to L2>L1. For example, the L2 is about 900 μm, and the L1 is about 890 μm. The length dimension from the shaft portion 80, that is the center of rotation of the gear 50, to the outer circumference of the rim portion 52, in other words, the length dimensions from the shaft portion 80 to the rigid tooth 60 and the elastic tooth 70, are the same dimensions.

Further, the gear 50 is formed, for example, by performing anisotropic etching through a photoresist pattern formed on the surface of a wafer-shaped substrate containing silicon to deeply etch the substrate in the thickness direction. That is, the gear 50 is manufactured using micro electromechanical systems (MEMS) technology. Therefore, respective portions of the tooth 51 including the rigid tooth 60 and the elastic tooth 70, the rim portion 52, the holding portion 53, the coupling portion 54, and the like of the gear 50 can be formed from the same substrate by the same etching process, and a plurality of gears 50 can be obtained from one substrate, which can improve the productivity of the gear 50 and reduce the production cost. In addition, since the gear 50 is formed using the photolithography or etching technique, there is an advantage that the degree of freedom of the shape is high, and the processing accuracy of the gear 50 can be improved.

In the present embodiment, the thickness of the silicon wafer is about 100 μm to about 200 μm. The thickness of the silicon wafer corresponds to the tooth width of the gear 50. The tooth tip circle (not shown), that is, the circle passing through the distal ends of the teeth 51, has a diameter of about 5 mm to about 7 mm. As shown in FIG. 4, a tooth thickness SA of the tooth 51 is an arc length on a pitch circle 59 in the free state, and is a sum of a thickness S1 of the rigid tooth 60, which is an arc length on the pitch circle 59, a thickness S2 of the elastic tooth 70, which is an arc length on the pitch circle 59, and a width dimension S3 of the slit 75 on the pitch circle 59. That is, SA=S1+S2+S3. The pitch circle 59 is a circle obtained by connecting pitch points at which the gear 50 as the first gear, and the pinion 28 or the seconds wheel 29 as the second gear mesh with each other. Therefore, the tooth thickness SA of the tooth 51 slightly varies depending on the shaft-to-shaft distance between the gear 50 and the pinion 28 or the seconds wheel 29 and the tooth shape, but in the present embodiment, the tooth thickness SA is about 190 μm to about 240 μm. The width of a tooth groove 55, which is an arc length of the tooth groove 55 on the pitch circle 59 between the adjacent teeth 51, is S5. The width S5 of the tooth groove 55 is about 60 μm to about 80 μm. The tooth groove 55 between the teeth 51 is a groove formed between the first acting tooth face 61 of the rigid tooth 60 of one tooth 51 of two adjacent teeth 51 and the first non-acting tooth face 71 of the elastic tooth 70 of the other tooth 51. The tooth width, the diameter of the tooth tip circle, the tooth thickness, and the width of the tooth groove are not limited to the above-described ranges, and may be outside the above-described ranges.

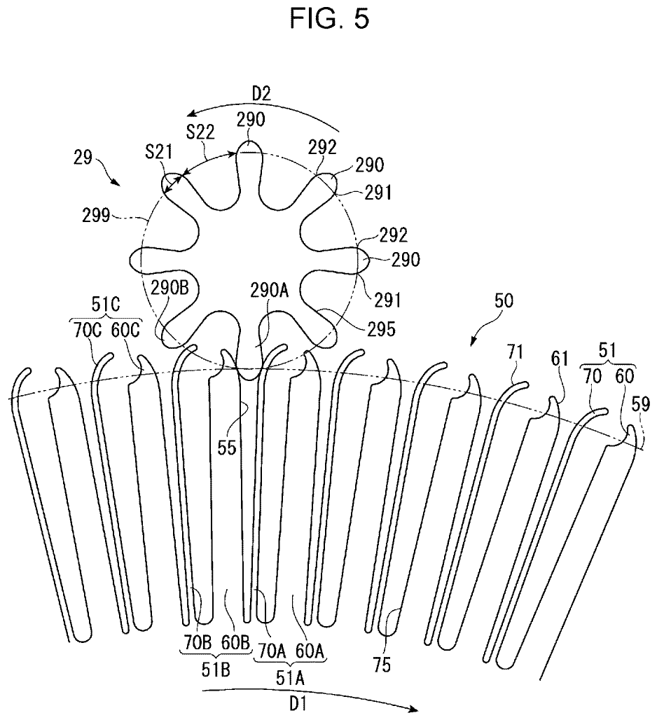

The tooth thickness SA of the tooth 51 of the gear 50 is set to be equal to or larger than a width dimension of a tooth groove of the pinion 28 or the seconds wheel 29 on a pitch circle. The pinion 28 and the seconds wheel 29 as the second gears are gears having the same size and shape, and for example, when the tooth thickness, which is an arc length of each tooth 290 of the seconds wheel 29 on a pitch circle 299, shown in FIG. 5, is S21, and the width of a tooth groove 295, which is an arc length of the tooth groove 295 between the teeth 290 on the pitch circle 299, is S22, S21 is about 70 μm to about 90 μm, and S22 is about 170 μm to about 190 μm.

Here, the tooth thickness SA of the tooth 51 is equal to or larger than the width S22 of the tooth groove 295 between the teeth 290. That is, SA≥S22. Therefore, in a state where the tooth 51 of the gear 50 as the first gear is disposed in the tooth groove 295 of the pinion 28 or the seconds wheel 29 as the second gear, the acting curved face 612 of the rigid tooth 60 contacts a second acting tooth face 291 of the tooth 290, and the non-acting curved face 712 of the elastic tooth 70 contacts a second non-acting tooth face 292 of the tooth 290. In this case, when the tooth thickness SA of the tooth 51 is greater than the width S22 of the tooth groove 295 between the teeth 290, that is, SA>S22, the elastic tooth 70 is elastically deformed in a direction toward the rigid tooth 60 in a state in which the tooth 51 of the gear 50 as the first gear is disposed in the tooth groove 295 of the pinion 28 or the seconds wheel 29 as the second gear, and the non-acting curved face 712 of the elastic tooth 70 contacts the second non-acting tooth face 292 of the tooth 290. When the tooth thickness SA of the tooth 51 is the same as the width S22 of the tooth groove 295 between the teeth 290, that is, SA=S22, the non-acting curved face 712 of the elastic tooth 70 contacts the second non-acting tooth face 292 of the tooth 290 even when the elastic tooth 70 is not elastically deformed in a state in which the tooth 51 of the gear 50 as the first gear is disposed in the tooth groove 295 of the pinion 28 or the seconds wheel 29 as the second gear. As a result, the rigid tooth 60 and the elastic tooth 70 contact the tooth 290, so that it is possible to compensate for a backlash.

Furthermore, the width S5 of the tooth groove 55 between the teeth 51 of the gear 50 is less than or equal to the tooth thickness S21 of the tooth 290 of the seconds wheel 29. That is, S5≤S21. Therefore, even in a state where each tooth 290 of the seconds wheel 29 as the second gear is disposed in the tooth groove 55 between the teeth 51 of the gear 50 as the first gear, the acting curved face 612 of the rigid tooth 60 contacts the second acting tooth face 291 of the tooth 290, and the non-acting curved face 712 of the elastic tooth 70 contacts the second non-acting tooth face 292 of the tooth 290. In this case, when the width S5 of the tooth groove 55 between the teeth 51 of the gear 50 is smaller than the tooth thickness S21 of the tooth 290 of the seconds wheel 29, that is, S5<S21, the elastic tooth 70 is elastically deformed in a direction toward the rigid tooth 60 in a state in which the tooth 290 of the seconds wheel 29 as the second gear is disposed in the tooth groove 55 between the teeth 51 of the gear 50 as the first gear, and the non-acting curved face 712 of the elastic tooth 70 contacts the second non-acting tooth face 292 of the tooth 290. When the width S5 of the tooth groove 55 between the teeth 51 of the gear 50 is the same as the tooth thickness S21 of the tooth 290 of the seconds wheel 29, that is, S5=S21, the non-acting curved face 712 of the elastic tooth 70 contacts the second non-acting tooth face 292 of the tooth 290 even when the elastic tooth 70 is not elastically deformed in a state where the tooth 290 of the seconds wheel 29 as the second gear is disposed in the tooth groove 55 between the teeth 51 of the gear 50 as the first gear. As a result, the rigid tooth 60 and the elastic tooth 70 contact the tooth 290, so that it is possible to compensate for a backlash.

The tooth thickness SA of the tooth 51 and the width S22 of the tooth groove 295 are set in consideration of manufacturing error. For example, in the present embodiment, since the gear 50 as the first gear is manufactured by the MEMS technology as described above, the first tolerance is about ±5 μm. The seconds wheel 29 as the second gear is manufactured by MEMS technology or machining, and the second tolerance in the case of being manufactured by the MEMS technology is approximately ±5 μm, and the second tolerance in the case of being manufactured by machining is approximately ±20 μm. The difference Δt between the tooth thickness SA of the tooth 51 and the width S22 of the tooth groove 295, that is, the designed amount of overlap Δt between the tooth 51 and the tooth 290, is set to a value equal to or greater than the sum of the first tolerance of the gear 50 and the second tolerance of the seconds wheel 29. For example, when both the gear 50 and the seconds wheel 29 are manufactured by the MEMS technology, the sum of the respective tolerances is about 10 μm, and when the gear 50 is manufactured by the MEMS technology and the seconds wheel 29 is manufactured by machining, the sum of the respective tolerances is about 25 μm. The gear 50 and the seconds wheel 29 are designed so that the difference Δt=SA−S22 between the tooth thickness SA of the tooth 51 and the width S22 of the tooth groove 295 is greater than or equal to the sum of the respective tolerances described above. As a result, in a case where the tooth 51 of the gear 50 meshes with the tooth groove 295 of the seconds wheel 29 even when there is a manufacturing error in the tooth shapes of the gear 50 and the seconds wheel 29, the rigid tooth 60 and the elastic tooth 70 can be reliably brought into contact with the tooth 290, and the backlash can also be reliably reduced.

Since the tooth thickness SA of the tooth 51 and the width S22 of the tooth groove 295 are dimensions on the pitch circles 59 and 299, the amount of overlap Δt also changes depending on the shaft-to-shaft distance between the gear 50 and the seconds wheel 29. Therefore, the amount of overlap Δt may be designed to be further increased in consideration of the manufacturing error of the shaft-to-shaft distance. In consideration of the sum of the respective tolerances and the error of the shaft-to-shaft distance, when both the gear 50 and the seconds wheel 29 are manufactured by the MEMS technology, the range of the amount of overlap Δt is about 10 μm to about 100 μm, and when the gear 50 and the seconds wheel 29 are manufactured by the MEMS technology and machining, the range of the amount of overlap Δt may be about 25 μm to about 100 μm. For example, when the shaft-to-shaft distance between the gear 50 and the seconds wheel 29 is changed by ±20 μm, that is, 40 μm at the maximum, the amount of overlap Δt is changed by, for example, about 30 μm. Therefore, when the difference between the tooth thickness SA of the tooth 51 and the width S22 of the tooth groove 295 is set to about 100 μm at the maximum, the rigid tooth 60 and the elastic tooth 70 can be reliably brought into contact with the tooth 290, and the backlash can be reliably reduced.

The width S5 of the tooth groove 55 between the teeth 51 and the tooth thickness S21 of the tooth 290 may be designed in consideration of the respective tolerances, the manufacturing error of the shaft-to-shaft distance, and the like, as in the tooth thickness SA of the tooth 51 and the width S22 of the tooth groove 295.

A meshing state between the gear 50 as the first gear and the seconds wheel 29 as the second gear will be described with reference to FIGS. 5 to 7. In the present embodiment, the gear 50 as the third wheel and pinion 26 transmits the motion to the pinion 28 and the seconds wheel 29. Therefore, in FIGS. 5 to 7, when the gear 50 rotates in a first direction D1 that is the clockwise direction, the rigid tooth 60 of the tooth 51 sequentially contacts the tooth 290 of the seconds wheel 29, and the seconds wheel 29 rotates in a second direction D2 that is the counterclockwise direction. At this time, a face of the tooth 290 of the seconds wheel 29, the face contacting the first acting tooth face 61 of the rigid tooth 60, is the second acting tooth face 291, and a face of the tooth 290 of the seconds wheel 29, the face contacting the first non-acting tooth face 71 of the elastic tooth 70, is the second non-acting tooth face 292.

FIG. 5 shows a state in which the tooth 290 of the seconds wheel 29 is disposed in the tooth groove 55 of the gear 50. In FIGS. 5 to 7, for convenience of description, some consecutive teeth 51, rigid teeth 60, and elastic teeth 70 are referred to as teeth 51A, 51B, and 51C, rigid teeth 60A, 60B, and 60C, and elastic teeth 70A, 70B, and 70C. Some consecutive teeth 290 meshing with the teeth 51A, 51B, and 51C are referred to as teeth 290A and 290B.

In FIG. 5, the first acting tooth face 61 of the rigid tooth 60B of the tooth 51B contacts the second acting tooth face 291 of the tooth 290A and transmits the motion. Further, the elastic tooth 70A disposed in the first direction D1 relative to the rigid tooth 60B in contact with the tooth 290A with the tooth groove 55 interposed between the elastic tooth 70A and the rigid tooth 60B contacts the second non-acting tooth face 292 of the tooth 290A, and the backlash is reduced. At this time, the elastic tooth 70A is elastically deformed in the first direction D1, that is, a direction toward the rigid tooth 60A. The slit 75 is formed between the rigid tooth 60A and the elastic tooth 70A so that the distal end of the elastic tooth 70A does not come into contact with the distal end of the rigid tooth 60A even when the elastic tooth 70A is elastically deformed toward the rigid tooth 60A. In addition, the elastic tooth 70B constituting the tooth 51B together with the rigid tooth 60B in contact with the tooth 290A, that is, the elastic tooth 70B disposed behind the rigid tooth 60B with respect to the first direction D1, that is, the rotation direction of the gear 50, is disposed at a position slightly away from the second non-acting tooth face 292 of the tooth 290B next to the tooth 290A.

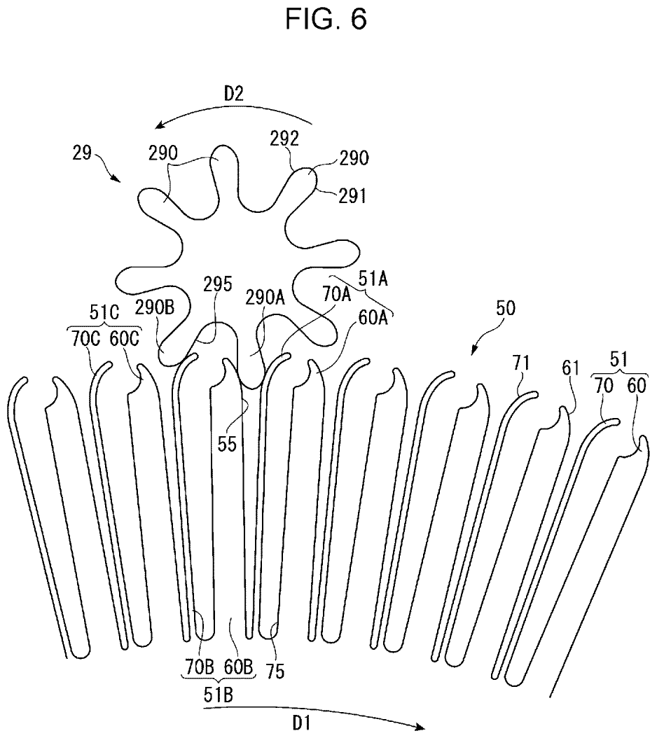

FIG. 6 shows a state in which the gear 50 has rotated slightly toward the first direction D1 from the state shown in FIG. 5. In FIG. 6, since the gear 50 has rotated in the first direction D1, the tooth 290A of the seconds wheel 29 disposed in the tooth groove 55 between the rigid tooth 60B and the elastic tooth 70A is pushed by the rigid tooth 60B and moves in the second direction D2. At this time, the elastic tooth 70A is kept in contact with the tooth 290A, and the backlash is reduced.

Further, the elastic tooth 70B is disposed at a position immediately before coming into contact with the second non-acting tooth face 292 of the tooth 290B.

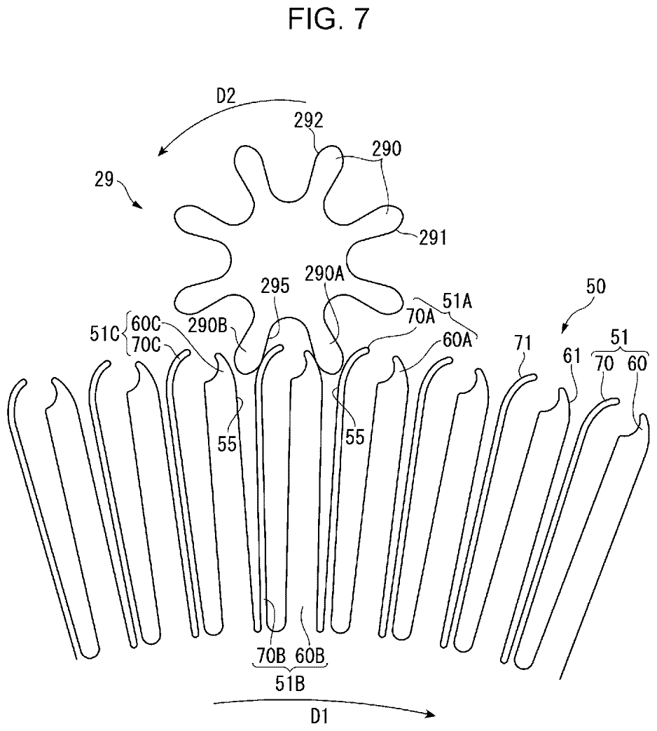

FIG. 7 shows a state where the gear 50 slightly rotates toward the first direction D1 from the state shown in FIG. 6. In FIG. 7, since the gear 50 rotates in the first direction D1, the tooth 290A of the seconds wheel 29 disposed in the tooth groove 55 between the rigid tooth 60B and the elastic tooth 70A is pushed by the rigid tooth 60B and moves in the second direction D2. The elastic tooth 70B contacts the second non-acting tooth face 292 of the tooth 290B. Accordingly, the rigid tooth 60B and the elastic tooth 70B of the tooth 51B are disposed in the tooth groove 295 between the tooth 290A and the tooth 290B. At this time, since the tooth thickness SA of the tooth 51B is larger than the width S22 of the tooth groove 295 between the teeth 290A and 290B, the elastic tooth 70B is elastically deformed in a direction toward the rigid tooth 60B, the rigid tooth 60B is brought into contact with the tooth 290A, and the elastic tooth 70B is brought into contact with the tooth 290B, and the backlash is reduced.

In FIG. 7, since the gear 50 rotates in the first direction D1, the elastic tooth 70A is away from the tooth 290A. Further, the rigid tooth 60C of the tooth 51C next to the tooth 51B is in a state immediately before contacting the second acting tooth face 291 of the tooth 290B.

Further, when the gear 50 rotates in the first direction D1, the rigid tooth 60C of the tooth 51C contacts the tooth 290B to rotate the seconds wheel 29 in the second direction D2, and the same state as in FIG. 5 is obtained. Therefore, by the rotation of the gear 50 in the first direction D1, the state from FIG. 5 to FIG. 7 is repeated, and the seconds wheel 29 rotates in the second direction D2. In addition, since at least one rigid tooth 60 is constantly in contact with the second acting tooth face 291 of the tooth 290 and at least one elastic tooth 70 is constantly in contact with the second non-acting tooth face 292 of the tooth 290, the seconds wheel 29 can be rotated while reducing a backlash, and the small seconds hand 6 attached to the seconds wheel 29 can be smoothly moved without variation.

The rigid tooth 60 and the elastic tooth 70 constituting the tooth 51 are assumed to have the acting curved face 612 and the non-acting curved face 712 in which tooth tips of the first acting tooth face 61 and the first non-acting tooth face 71 are curved in a direction toward each other. Therefore, the tooth thickness of the tooth 51 gradually decreases toward the tooth tip, and the width dimension of the tooth groove 55 gradually increases toward the tooth tip. Therefore, the tooth 51 can smoothly enter the tooth groove 295 of the seconds wheel 29, and the tooth 290 can smoothly enter the tooth groove 55 of the gear 50.

Further, since the length dimension L2 from the rim portion 52 to the distal end of the elastic tooth 70 is longer than the length dimension L1 from the rim portion 52 to the distal end of the rigid tooth 60, when the elastic tooth 70 starts to contact the tooth 290, the non-acting curved face 712 of the elastic tooth 70 contacts the tooth 290, so that the elastic tooth 70 can be bent smoothly. For example, when the distal end face of the elastic tooth 70 contacts the tooth 290, the elastic tooth 70 and the tooth 290 are pressed against each other, which hinders the rotation of the gear 50 and the seconds wheel 29. On the other hand, in the present embodiment, since the length dimension L2 of the elastic tooth 70 is large and the distal end of the elastic tooth 70 is curved toward the rigid tooth 60, the distal end of the elastic tooth 70 does not contact the tooth 290, and the non-acting curved face 712 continuous from the distal end contacts the second non-acting tooth face 292 of the tooth 290, and the elastic tooth 70 bends smoothly, so that the gear 50 and the seconds wheel 29 also rotate smoothly.

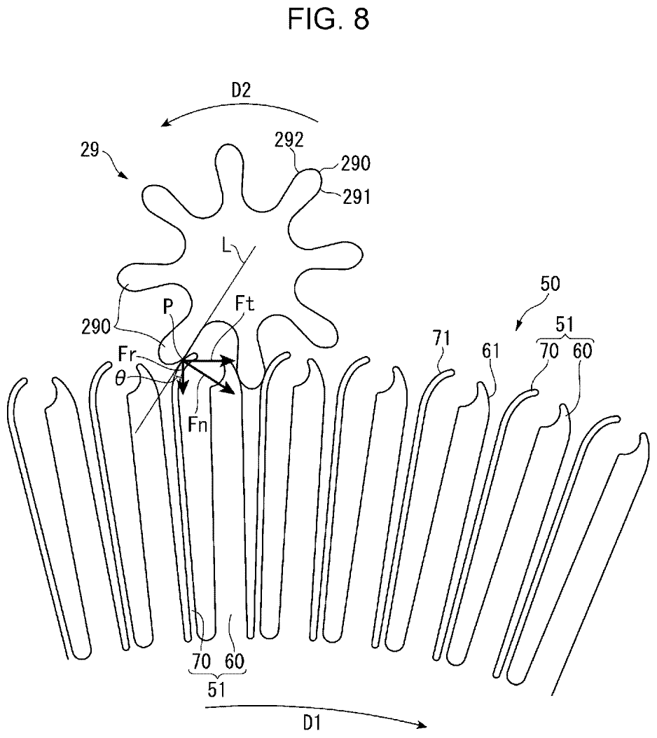

FIG. 8 shows a force applied from the tooth 290 to the elastic tooth 70 when the elastic tooth 70 starts to contact the tooth 290. As shown in FIG. 8, the elastic tooth 70 starts to receive a force from the seconds wheel 29 at a contact point P where the elastic tooth 70 contacts the tooth 290. At the time when this force starts to be received, a force Fn perpendicular to a tangent line L of the tooth face of the elastic tooth 70 at the contact point P is applied from the seconds wheel 29. The force Fn can be resolved into a tangential force Ft and a radial force Fr. The tangential direction, which is a vector direction of the force Ft, is a direction of a tangent line at the contact point P of a circle that is centered on the rotation shaft of the gear 50 and passes through the contact point P. The radial direction, which is a vector direction of the force Fr, is a radial direction of the gear 50.

In the state shown in FIG. 8, the shape of the first non-acting tooth face 71 of the elastic tooth 70, that is, the shape of the non-acting curved face 712 in contact with the tooth 290, is set so that the magnitude of the force Ft>the magnitude of the force Fr is satisfied. That is, an inclination angle θ of the tangent line L at the contact point P is set to be smaller than 45°. The inclination angle θ is an angle between the tangent line L and the radial direction of the gear 50. On the other hand, in a case where the elastic tooth 70 is set in such a shape that the distal end thereof contacts the tooth 290, the magnitude of the force Ft≤the magnitude of the force Fr, and the inclination angle θ is 45° or more. In this case, the elastic tooth 70 does not bend inward well, and the seconds wheel 29 may hinder the rotation of the gear 50.

According to the present embodiment, the following effects are obtained.

Each tooth 51 of the gear 50 includes the rigid tooth 60 and the elastic tooth 70, and the first acting tooth face 61 of the rigid tooth 60 contacts the second acting tooth face 291 of the seconds wheel 29 to transmit the motion between the gear 50 and the seconds wheel 29, so that the rigid tooth 60 is not elastically deformed when transmitting the motion, and the motion can be transmitted reliably and appropriately between the gear 50 and the seconds wheel 29.

As shown in FIG. 7, since the tooth 51 includes the elastic tooth 70, and the tooth thickness SA of the tooth 51 is equal to or larger than the width S22 of the tooth groove 295 of the seconds wheel 29, when the rigid tooth 60 and the elastic tooth 70 of the tooth 51 are disposed in the tooth groove 295 of the seconds wheel 29, the first acting tooth face 61 of the rigid tooth 60 contacts the second acting tooth face 291 of the tooth 290, and the first non-acting tooth face 71 contacts the second non-acting tooth face 292 of the tooth 290, so that it is possible to reduce and compensate for a backlash.

Further, since the width S5 of the tooth groove 55 is smaller than the tooth thickness S21 of the tooth 290, as shown in FIG. 5, even when the tooth 290 is caught in the tooth groove 55 between the rigid tooth 60 and the elastic tooth 70, the elastic tooth 70 contacts the tooth 290, and it is possible to reduce and compensate for a backlash.

Therefore, according to the gear set of the gear 50 and the seconds wheel 29 or the pinion 28, it is possible to reliably and appropriately transmit the motion while reducing the backlash.

Since the tooth thickness SA of the tooth 51 and the width S5 of the tooth groove 55 of the gear 50, and the tooth thickness S21 of the tooth 290 and the width S22 of the tooth groove 295 of the seconds wheel 29 are set in consideration of the tolerances of the gear 50 and the seconds wheel 29, the rigid tooth 60 and the elastic tooth 70 can be reliably brought into contact with the tooth 290 even when a manufacturing error occurs in the tooth shapes of the gear 50 and the seconds wheel 29, and the backlash can be reduced. Therefore, the vibration of the small seconds hand 6 attached to the seconds wheel 29 due to the backlash can be reduced, and the small seconds hand 6 can be moved smoothly. Further, since the tooth thicknesses SA and S21, and the widths S5 and S22 of the tooth grooves are set in consideration of the manufacturing error of the shaft-to-shaft distance between the gear 50 and the seconds wheel 29, the rigid tooth 60 and the elastic tooth 70 can be reliably brought into contact with the tooth 290 even when a manufacturing error occurs in the shaft-to-shaft distance between the gear 50 and the seconds wheel 29, and the backlash can be reduced.

Since a portion of the first non-acting tooth face 71 of the elastic tooth 70, the portion contacting the tooth 290, is the non-acting curved face 712, and the tooth shape of the elastic tooth 70 is set so that the inclination angle θ when the non-acting curved face 712 starts to contact the second non-acting tooth face 292 is less than 45°, the non-acting curved face 712 of the elastic tooth 70 can be reliably brought into contact with the tooth 290 and the elastic tooth 70 can be smoothly bent and deformed. Therefore, it is possible to prevent the distal end of the elastic tooth 70 from contacting the tooth 290 and hindering the rotation of the gear 50 and the seconds wheel 29.

Since the slit 75 is formed between the rigid tooth 60 and the elastic tooth 70, and when the gear 50 meshes with the seconds wheel 29, the rigid tooth 60 and the elastic tooth 70 are not brought into contact with each other, the elastic tooth 70 can be elastically deformed by a small force, and the transmission efficiency of the gear set by the gear 50 and the seconds wheel 29 can be improved.

Since the length dimension L2 of the elastic tooth 70 is longer than the length dimension L1 of the rigid tooth 60, the force that elastically deforms the elastic tooth 70 can be made small, compared with a case in which the length dimension of the elastic tooth 70 is shorter than the length dimension of the rigid tooth 60. Therefore, the energy for elastically deforming the elastic tooth 70 can be reduced, which can improve the transmission efficiency of the gear set.

Since the length dimensions from the rotation shaft of the gear 50 to the rigid tooth 60 and the elastic tooth 70 are the same, that is, the length dimensions from the rotation shaft of the gear 50 to the tooth bottoms of the tooth groove 55 and the slit 75 are the same, the shapes of the rigid tooth 60 and the elastic tooth 70 can be simplified, the etching shape at the time of plasma etching can be easily ensured, and the manufacturing efficiency can be improved. Further, since the rigid tooth 60 and the elastic tooth 70 extend from the rim portion 52 in the radial direction of the gear 50 and have a simple shape in which only the distal end is curved, it is possible to easily ensure an etching shape and to improve manufacturing efficiency.

The above-described embodiment may be modified as follows.

In the above-described embodiment, silicon, which is a plate-shaped member made of a brittle material, is used as the material of the gear 50, but the material of the gear 50 is not limited to silicon. For example, silicon carbide, quartz, glass, sapphire, or the like may be used.

In the above embodiment, the slit 75 between the rigid tooth 60 and the elastic tooth 70 is set such that the elastic tooth 70 does not contact the rigid tooth 60 when the elastic tooth 70 contacts the tooth 290 and is bent by elastic deformation, but the slit 75 may be set such that the elastic tooth 70 contacts the rigid tooth 60 when the elastic tooth 70 contacts the tooth 290 and is bent by elastic deformation. However, from the viewpoint of improving the transmission efficiency, it is preferable to set the slit 75 such that the entire elastic tooth 70 from the tooth root to the tooth tip does not come into contact with the rigid tooth 60 when the elastic tooth 70 is bent. For example, when the elastic tooth 70 has a shape that comes into contact with the rigid tooth at a midpoint from the tooth root to the tooth tip, the region that can be elastically deformed when in contact is a region from the midpoint to the tooth tip of the elastic tooth 70. This is equivalent to a reduction in the length of the elastic tooth 70. When the length of the elastic tooth 70 is shortened, the flexibility is reduced, and more energy is required to bend the elastic tooth 70. Therefore, the transmission efficiency is reduced compared with a shape in which the entire elastic tooth 70 from the tooth root to the tooth tip does not come into contact with the rigid tooth 60.

In the embodiment described above, the gear 50 of the third wheel and pinion 26 constituting the front train wheel of the mechanical timepiece 1 is exemplified, but the structure and the manufacturing method of the gear 50 shown in the embodiment described above can be applied to various gears such as other gears constituting the front train wheel and gears constituting the back train wheel. Further, the timepiece is not limited to the mechanical timepiece 1, and may be another timepiece such as an electronic timepiece. That is, the structure and the manufacturing method of the gear 50 shown in the embodiment described above can also be applied to a gear included in an electronic timepiece or the like.

### SUMMARY OF PRESENT DISCLOSURE

The present disclosure features a gear set including a first gear, and a second gear. Each tooth of the first gear includes a rigid tooth including a first acting tooth face that transmits motion to the second gear or to which motion from the second gear is transmitted and an elastic tooth provided away from the rigid tooth via a slit, configured to bend in a direction toward the rigid tooth when the elastic tooth meshes with the second gear, and including a first non-acting tooth face that contacts the second gear. A tooth thickness of each tooth of the first gear, the tooth thickness being a sum of a thickness of the rigid tooth, a width dimension of the slit, and a thickness of the elastic tooth of the first gear on a pitch circle of the first gear in a free state in which the first gear does not mesh with the second gear, is equal to or larger than a width of a tooth groove of the second gear on a pitch circle of the second gear, and a width of a tooth groove of the first gear on the pitch circle of the first gear is equal to or less than a tooth thickness of each tooth of the second gear on the pitch circle of the second gear.

According to the gear set of the present disclosure, each tooth of the first gear includes the rigid tooth and the elastic tooth provided away from each other via the slit, and the first acting tooth face of the rigid tooth can contact the second acting tooth face of the second gear to transmit the motion between the first gear and the second gear, so that it is possible to reliably and appropriately transmit the motion between the first gear and the second gear.

The tooth thickness of each tooth of the first gear is the sum of the thickness of the rigid tooth, the width dimension of the slit, and the thickness of the elastic tooth on the pitch circle of the first gear in the free state, and this tooth thickness is equal to or greater than the width of the tooth groove on the pitch circle of the second gear, so that, in a state in which the rigid tooth and the elastic tooth of one tooth of the first gear are disposed in the tooth groove of the second gear, the first acting tooth face of the rigid tooth contacts the second gear, and the elastic tooth contacts the second gear by elastic deformation, and the like, thereby reducing and compensating for a backlash. Further, since the width of the tooth groove of the first gear on the pitch circle of the first gear is equal to or smaller than the tooth thickness of the second gear on the pitch circle of the second gear, even when a tooth of the second gear is sandwiched between an elastic tooth of one tooth of the first gear and a rigid tooth of the next tooth, the elastic tooth is, for example, elastically deformed to contact the second gear, thereby reducing and compensating for a backlash.

In the gear set according to the present disclosure, it is preferable that a difference between the tooth thickness of each tooth of the first gear and the width of the tooth groove of the second gear be equal to or larger than a sum of a first tolerance that is a manufacturing error of the first gear and a second tolerance that is a manufacturing error of the second gear.

According to the present disclosure, since the difference between the tooth thickness of each tooth of the first gear and the width of the tooth groove of the second gear is equal to or larger than the sum of the first tolerance as the manufacturing error of the first gear and the second tolerance as the manufacturing error of the second gear, the rigid tooth and the elastic tooth can be reliably brought into contact with the second gear to reduce and compensate for a backlash even when there is a manufacturing error in the tooth shapes of the first gear and the second gear.

In the gear set according to the present disclosure, it is preferable that the slit of the first gear be configured so that the rigid tooth and the elastic tooth do not contact each other when the first gear meshes with the second gear.

According to the present disclosure, when the tooth of the first gear meshes with the second gear, the rigid tooth and the elastic tooth do not contact each other. Therefore, the elastic tooth can be elastically deformed with a small force, which can improve the transmission efficiency of the first gear and the second gear.

In the gear set of the present disclosure, it is preferable that the first acting tooth face of the rigid tooth include an acting tooth root face extending from a rim portion of the first gear along a radial direction, and an acting curved face extending from the acting tooth root face toward a tooth tip and curved toward the elastic tooth to contact the second gear, and the first non-acting tooth face of the elastic tooth include a non-acting tooth root face extending from the rim portion along the radial direction, and a non-acting curved face extending from the non-acting tooth root face toward a tooth tip and curved toward the rigid tooth to contact the second gear.

According to the present disclosure, the acting curved face of the rigid tooth and the non-acting curved face of the elastic tooth are brought into contact with the tooth of the second gear, whereby the elastic tooth can be reliably bent, and the first gear and the second gear can be reliably rotated.

In the gear set of the present disclosure, it is preferable that the first non-acting tooth face of the elastic tooth have a shape satisfying a magnitude of a force Ft>a magnitude of a force Fr when a force Fn applied from the second gear in a direction perpendicular to a tangent line at a contact point on the first non-acting tooth face is resolved into the force Ft in a tangent direction at the contact point of a circle centered on a rotation shaft of the first gear and passing through the contact point and the force Fr in a radial direction of the first gear, at a timing at which the second gear and the first non-acting tooth face start to contact each other.

According to the present disclosure, when the tooth of the first gear meshes with the second gear, the elastic tooth can be appropriately bent toward the rigid tooth, and the first gear and the second gear can be appropriately rotated.

In the gear set according to the present disclosure, it is preferable that the first gear or the second gear be a gear to which a hand is attached.

According to the present disclosure, since the backlash of the first gear or the second gear is compensated for, it is possible to reduce the vibration of the hand attached to these gears due to the backlash.

A movement of the present disclosure includes the gear set.

According to the present disclosure, since the movement includes the gear set, it is possible to appropriately transmit motion between the first gear and the second gear, and to reduce the backlash.

A timepiece of the present disclosure includes the movement.

According to the present disclosure, since the movement is included, the motion can be appropriately transmitted between the first gear and the second gear, and the backlash can be reduced.

1. A gear set comprising:
a first gear; and a second gear, wherein
each tooth of the first gear includes
a rigid tooth including a first acting tooth face that transmits motion to the second gear or to which motion from the second gear is transmitted and
an elastic tooth provided away from the rigid tooth via a slit, configured to bend in a direction toward the rigid tooth when the elastic tooth meshes with the second gear, and including a first non-acting tooth face that contacts the second gear,
a tooth thickness of each tooth of the first gear, the tooth thickness being a sum of a thickness of the rigid tooth, a width dimension of the slit, and a thickness of the elastic tooth of the first gear on a pitch circle of the first gear in a free state in which the first gear does not mesh with the second gear, is equal to or larger than a width of a tooth groove of the second gear on a pitch circle of the second gear, and
a width of a tooth groove of the first gear on the pitch circle of the first gear is equal to or less than a tooth thickness of each tooth of the second gear on the pitch circle of the second gear.

2. The gear set according to claim 1, wherein
a difference between the tooth thickness of each tooth of the first gear and the width of the tooth groove of the second gear is equal to or larger than a sum of a first tolerance that is a manufacturing error of the first gear and a second tolerance that is a manufacturing error of the second gear.

3. The gear set according to claim 1, wherein
the slit of the first gear is configured so that the rigid tooth and the elastic tooth do not contact each other when the first gear meshes with the second gear.

4. The gear set according to claim 1, wherein
the first acting tooth face of the rigid tooth includes an acting tooth root face extending from a rim portion of the first gear along a radial direction, and an acting curved face extending from the acting tooth root face toward a tooth tip and curved toward the elastic tooth to contact the second gear, and
the first non-acting tooth face of the elastic tooth includes a non-acting tooth root face extending from the rim portion along the radial direction, and a non-acting curved face extending from the non-acting tooth root face toward a tooth tip and curved toward the rigid tooth to contact the second gear.

5. The gear set according to claim 1, wherein
the first non-acting tooth face of the elastic tooth has a shape satisfying a magnitude of a force Ft>a magnitude of a force Fr when a force Fn applied from the second gear in a direction perpendicular to a tangent line at a contact point on the first non-acting tooth face is resolved into the force Ft in a tangent direction at the contact point of a circle centered on a rotation shaft of the first gear and passing through the contact point and the force Fr in a radial direction of the first gear, at a timing at which the second gear and the first non-acting tooth face start to contact each other.

6. The gear set according to claim 1, wherein
the first gear or the second gear is a gear to which a hand is attached.

7. A movement comprising: the gear set according to claim 1.

8. A timepiece comprising: a movement according to claim 7.
